(19) United States
(12) Patent Application Publication
(10) Pub. No.: US 2009/0325423 A1
(43) Pub. Date: Dec. 31, 2009

(54) Adapter for a main current path tap of a switching device

(76) Inventors: Georg Bollinger, Schwarzhofen (DE); Johann Drexler, Schwandorf (DE); Bardo Koppmann, Kaltenbrunn (DE); Arno Schneiderhan, Schlusselfeld (DE)

Correspondence Address: HARNESS, DICKEY & PIERCE, P.L.C., P.O.BOX 8910, RESTON, VA, 20195, US

(21) Appl. No.: 12/311,133

(22) PCT Filed: Sep. 21, 2006
(86) PCT No.: PCT/DE2006/001683

§ 371 Date: Apr. 24, 2009

(51) Int. Cl. H01R 31/02

(52) U.S. Cl. 439/638

(57) ABSTRACT

At least one embodiment of the invention relates to an adapter for producing an electrically conductive connection between at least one main current path of a switching device and an evaluation unit for determining the state of a protective apparatus, which is connected upstream of the switching device. In order to make it possible to monitor a protective apparatus which is connected upstream of the switching device with minimum wiring complexity, at least one embodiment of the invention proposes an adapter for producing an electrically conductive connection between at least one main current path of a switching device and an evaluation unit for determining the state of a protective apparatus which is connected upstream of the switching device, wherein the adapter can be connected mechanically to the switching device and has contact interfaces for connection of the evaluation unit. As a result of the direct evaluation of the switching state of the protective organ on the switching device, the wiring which until now has been necessary for an additional auxiliary switch on the protective device is dispensed with, a possible fault source also being minimized with the wiring complexity.

### PRIORITY STATEMENT

This application is the national phase under 35 U.S.C. § 371 of PCT International Application No. PCT/DE2006/001683 which has an International filing date of Sep. 21, 2006, which designated the United States of America, the entire contents of each of which are hereby incorporated herein by reference.

### FIELD OF THE INVENTION

At least one embodiment of the invention generally relates to an adapter for producing an electrically-conductive connection between at least one main current path of a switching device and an evaluation unit for determining the state of a protective device which is connected upstream of the switching device.

At least one embodiment of the invention further generally relates to an evaluation unit for determining the state of a protective device connected upstream of a switching device with at least one main current path, a communication module for a switching device with at least one main current path for communication with the switching device and a control for the switching device over at least one communication connection in each case and/or a system comprising a switching device and a protective device connected upstream of this which are able to be connected via at least one main current path, an adapter and an evaluation unit.

### BACKGROUND

An adapter or a system is used in particular for load branches, such as motor starters for example. Switching devices for load branches are used in switching systems for example which as a rule are protected from short circuits at a number of levels (feed, distribution, loads). In such cases the state of the motor starter for example is characterized by the activation of the switching device, for example a contactor, by the feedback of the controlled switching device state as well as by the notification of the state of the at least one upstream protective device, which can be a power switch, a fuse or an overvoltage protection relay.

The underlying problem is that, as a result of the typical configuration in the switching cabinet, outlay for the cabling of these signals arises, since each branch requires six lines, either directly to a control, such as a Programmable Logic Controller (PLC), for the switching device, or to a communication interface connected to the PLC via a communication link such as a field bus system or a point-to-point connection for example. Even if communication systems are used to save cabling there must still be cabling to the protective device. In this case the state of the protective device is notified by an additional auxiliary switch on the protective device, but this does not detect the presence of a voltage at the switching device however. The high cabling outlay makes these conventional solutions not only time-consuming and costly, but they also conceal a possible source of errors within the cabling.

### SUMMARY

At least one embodiment of the invention specifies an adapter for a switching device which allows monitoring of a protective device connected upstream from the switching device with minimal cabling outlay.

At least one embodiment of the invention also specifies an evaluation unit, a communication module, a switching device and/or a system comprising a switching device, a protective device connected upstream thereof, an adapter and an evaluation unit.

At least one embodiment is directed to an adapter for producing an electrically-conductive connection between at least one main current path of a switching device and an evaluation unit for determining the state of a protective device connected upstream of the switching device, with the adapter being able to be mechanically connected to the switching device and having contact interfaces for connecting the evaluation unit.

At least one embodiment is directed to an evaluation unit, a communication module, a switching device and/or a system.

In at least one embodiment, the at least one main current path of the switching device is connected via an electrically-conductive connection to a respective contact interface at the adapter. The evaluation unit can then be connected at these contact interfaces (contact points, surfaces or locations), e.g. as an additional module, with no or only with small changes at the switching device. In this case the state of the protective device can be determined by the evaluation unit by measuring a voltage on the at least one main current path. This is the simplest method of obtaining the additional information that a voltage is present at the switching device. By this direct evaluation of the switching state of the protective organ at the switching device the previously required cabling to an additional auxiliary switch is dispensed with, with a possible source of faults being minimized along with the cabling outlay. To this end the proposed solution is also independent of the spatial layout (branch or row-oriented) in a switching cabinet and, with small changes on the switching device, also independent of the connection technology.

In an advantageous form of the embodiment the adapter has at least one connecting lug for tapping the at least one main current path in a connection area. The tapping in the connection area, in which the cables to a load or a protective device are connected for example, means that with this embodiment of the adapter no changes are required to the switching device. However the adapter must be adapted here to the type of connection to be used.

In a further advantageous embodiment, the adapter has at least one spring element for tapping the at least one main current path by a recess provided in the switching device in each case for the insertion of the at least one spring element. Although this does require a small change to be made to the switching device, it makes this solution independent of the type of connection used, such as screw terminal, spring-loaded terminal or fast-on connector.

### BRIEF DESCRIPTION OF THE DRAWINGS

The invention is described and explained in more detail below on the basis of the example embodiments shown in the figures. The figures are as follows:

FIG. 1 an example embodiment of an adapter with connecting lugs,

FIG. 2 a further example embodiment of an adapter with connecting lugs,

FIG. 3 an example embodiment of an adapter with spring elements,

FIG. 4 a further example embodiment of an adapter with spring elements,

FIG. 5 a communication module with an integrated evaluation unit,

FIG. 6 an example embodiment of a switching device which is connected to the adapter depicted in FIG. 3,

FIG. 7 a further example embodiment of a switching device which is connected to the adapter from FIG. 4.

### DETAILED DESCRIPTION OF THE EXAMPLE EMBODIMENTS

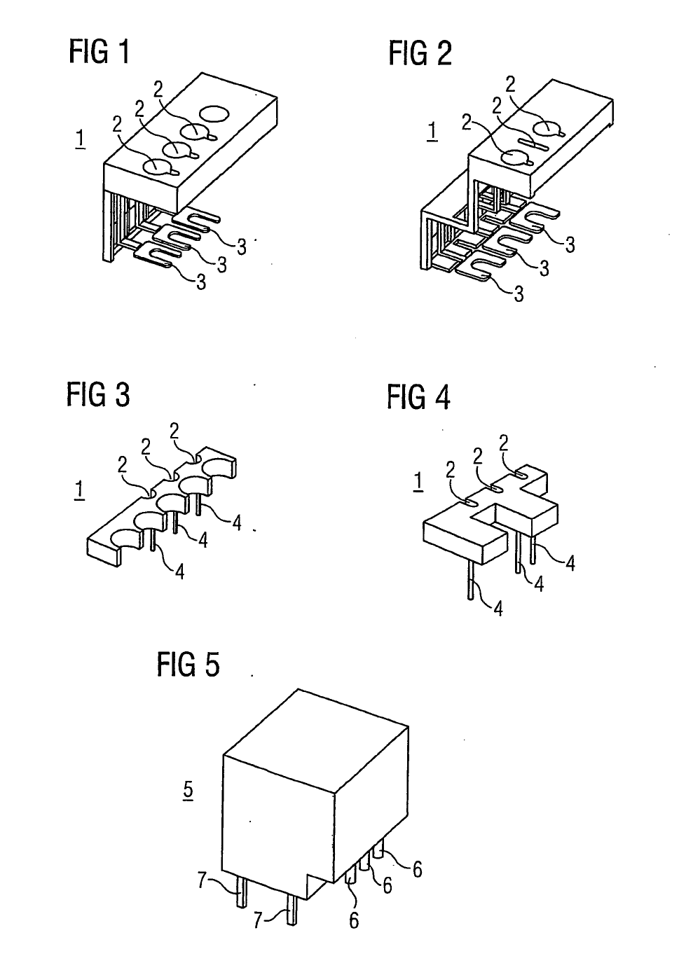

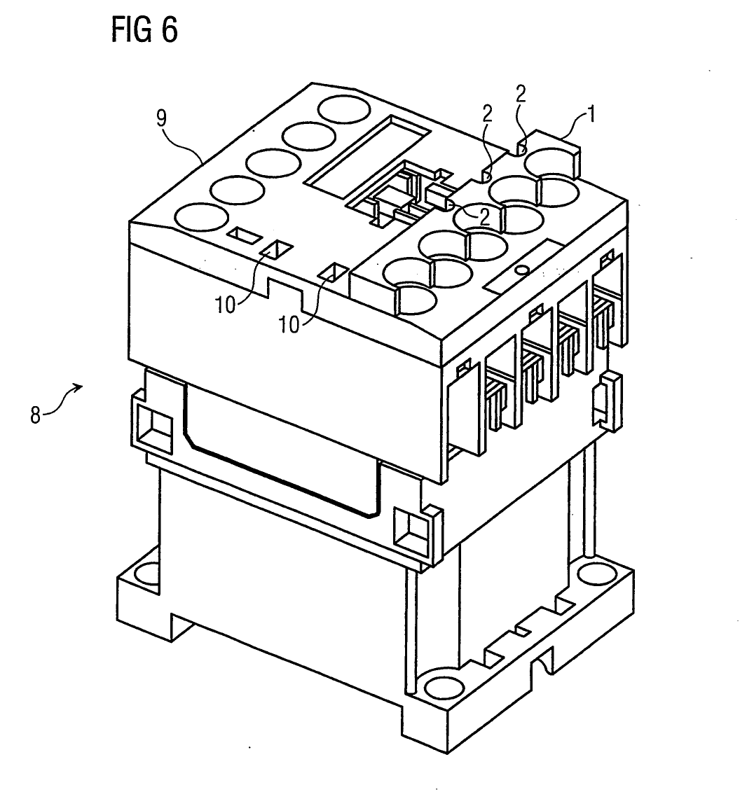

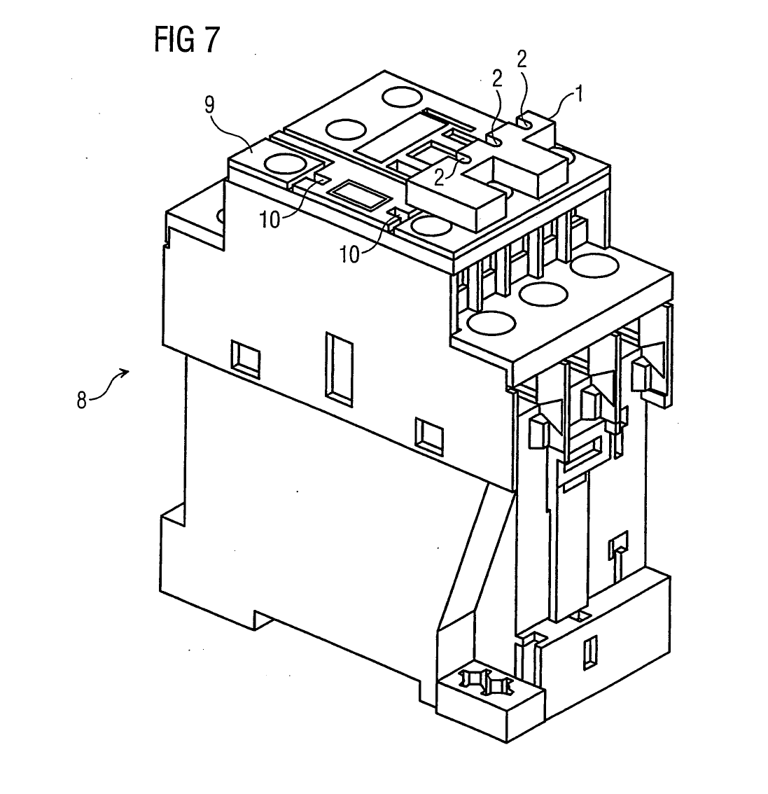

FIGS. 1 and 2 each show an adapter 1 with contact interfaces for an evaluation unit 2 and connecting lugs 3, by which the main current path is tapped in a connection area of a switching device. For installation the adapter 1 is put onto the switching device, the attachment to and contacting of the main current path is carried out in the embodiment shown by way of a screw connection. The shape of the two adapters 1 is adapted for different switching devices, cf. FIG. 6 and 7.

Both adapters 1 have three terminal lugs 3 for tapping three main current paths, with the tapping in the connection area meaning that no changes are required at the switching device. The evaluation unit, which determines the state of a protective device connected upstream from the switching device, by way of a voltage measurement for example, can be connected to the contact interface for the evaluation unit 2 (i.e. different adapters 1, but common contact interfaces for the evaluation unit 2).

FIGS. 3 and 4 each show an adapter 1 with contact interfaces for an evaluation unit 2 and spring elements 4 such as sprung pins for electrical contacting of the main current path of a switching device and for allowing for tolerances for example. Here too the different forms of the adapter 1 are provided for different types of switching device, see FIGS. 6 and 7, in which the adapters 1 are shown with the appropriate switching devices. Thus for example the spring elements 4 of the adapter in FIG. 4 for the switching device in FIG. 7 are embodied somewhat longer.

Tapping by way of the spring elements 4 means however with this embodiment that small changes to the switching device 8 are necessary, since this must have suitable cutouts for the spring elements 4. For this reason the adapter solution shown in these figures is independent of the connection type (e.g. screw terminal, spring-loaded terminal or fast-on connector).

FIG. 5 shows a communication module 5 with an integrated evaluation unit. The contact interfaces of the evaluation unit 6 contact the corresponding contact interfaces 2 of the adapter 1, see FIGS. 1 to 4. A communication link between communication module 5 and switching device 8, for example for controlling the coil of the switching device 8, is provided by the communication interfaces 7. In this embodiment the communication module 5 is able to be electrically connected to the switching device 8 simply by plugging into the corresponding contact interfaces 2, 10. The mechanical connection is made via a coupling point of the switching device 8.

FIGS. 6 and 7 each show a switching device 8 with contact interfaces 10 in a housing 9 for a communication link with a communication module 5. Connected mechanically to the switching device 8, by plugging it in in each case, is an adapter with contact interfaces for an evaluation unit 2, as shown in FIG. 3 or FIG. 4. To accept the spring elements 4 of the adapter 1 the switching device 8 has recesses through which the spring elements 4 can contact the main current path of the switching device 8.

In summary, at least one embodiment of the invention relates to an adapter for establishing an electrically-conductive connection between at least one main current path of a switching device and an evaluation unit for determining the state of a protective device connected upstream of the switching device. To enable the protective device connected upstream of the switching device to be monitored with minimal cabling outlay, an adapter is proposed for establishing an electrically-conductive connection between at least one main current path of a switching device and an evaluation unit for determining the state of a protective device connected upstream of the switching device, with the adapter being connected mechanically to the switching device and featuring contact interfaces for connecting the evaluation unit. The direct evaluation of the switching state of the protective organ at the switching device means that previously required cabling to an additional auxiliary switch on the protective device is dispensed with, with the minimized cabling outlay also minimizing a possible source of faults.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An adapter for establishing an electrically-conductive connection between at least on main current path of a switching device and an evaluation unit for determining the state of a protective device connected upstream of the switching device, the adapter being connected mechanically to the switching device and including contact interfaces for connecting the evaluation unit.

2. The adapter as claimed in claim 1, further including
at least one connecting lug for tapping the at least one main current path in a connection area.

3. The adapter as claimed in claim 1, further including
at least one spring element for tapping the at least one main current path through a respective recess provided in the switching device for insertion of the at least one spring element.

4. An evaluation unit for determining the state of a protective unit connected upstream of a switching device with at least one main current path, the evaluation unit comprising:
at least one contact interface for contacting the at least one main current path by way of a respective contact interface of an adapter is the adapter being connected via an electrically-conductive connection of the adapter box with tapping of the at least one main current path; and
means for establishing a detachable mechanical connection with the switching device.

5. A communication module for a switching device with at least a main current path for communication with the switching device and a control for the switching device via at least one communication link, the at least one communication link with the switching device being embodied as at least one contact interface in a housing of the switching device and the communication module being embodied such that an evaluation unit as claimed in claim 4 is integrated into the communication module.

6. A switching device including at least one main current path, comprising:
at least one recess, provided for an insertion of a spring element of an adapter, for establishing a conductive connection between the main current path and an evaluation unit for determining the state of a protective device connected upstream of the switching device.

7. A system comprising:
a switching device including at least one main current path, comprising at least one recess, provided for an insertion of a spring element of an adapter, for establishing a conductive connection between the main current path and an evaluation unit for determining the state of a protective device connected upstream of the switching device;
a protective device connected upstream of the switching device, the switching device and the protective device being connectable via at least one main current path;
an adapter for establishing an electrically-conductive connection between at least on main current path of a switching device and an evaluation unit for determining the state of a protective device connected upstream of the switching device, the adapter being connected mechanically to the switching device and including contact interfaces for connecting the evaluation unit; and
an evaluation unit as claimed in claim 4.

8. A system comprising:
a switching device including at least one main current path, comprising at least one recess, provided for an insertion of a spring element of an adapter, for establishing a conductive connection between the main current path and an evaluation unit for determining the state of a protective device connected upstream of the switching device;
a protective device connected upstream of the switching device, the switching device and the protective device being connectable via at least one main current path;
an adapter for establishing an electrically-conductive connection between at least on main current path of a switching device and an evaluation unit for determining the state of a protective device connected upstream of the switching device, the adapter being connected mechanically to the switching device and including contact interfaces for connecting the evaluation unit; and
an evaluation unit as claimed in claim 4; and
a communication module for a switching device with the system featuring a communication module for a switching device with at least a main current path for communication with the switching device and a control for the switching device via at least one communication link, the at least one communication link with the switching device being embodied as at least one contact interface in a housing of the switching device and the communication module being embodied such that the evaluation unit is integrated into the communication module.

9. The system as claimed in claim 7, wherein the switching device is embodied as a contactor.

10. The system as claimed in claim 7, wherein
the protective device is embodied as a power switch or overload relay.

11. The system as claimed in claim 8, wherein the switching device is embodied as a contactor.

12. The system as claimed in claim 8, wherein the protective device is embodied as a power switch or overload relay.

13. The system as claimed in claim 9, wherein the protective device is embodied as a power switch or overload relay.
